(19) United States
(12) Patent Application Publication
(10) Pub. No.: US 2014/0325400 A1
(43) Pub. Date: Oct. 30, 2014

(54) MULTI-PANEL VIEW INTERFACE FOR A BROWSER OPERATING ON A COMPUTING DEVICE

(71) Applicant: HEWLETT-PACKARD DEVELOPMENT COMPANY, L.P., Houston, TX (US)

(72) Inventors: Colin Zhao, Palo Alto, CA (US); Itai Vonshak, Palo Alto, CA (US); Angela Tam, Palo Alto, CA (US); Robert Chen, Palo Alto, CA (US); Ben Rottler, Palo Alto, CA (US); Chad Wirtz, Palo Alto, CA (US)

(73) Assignee: Hewlett-Packard Development Company, L.P., Houston, TX (US)

(21) Appl. No.: 13/874,345

(22) Filed: Apr. 30, 2013

(51) Int. Cl. G06F 3/0482

(52) U.S. Cl. CPC G06F 3/0482
USPC 715/760

(57) ABSTRACT

A method for operating a computing device is provided. One or more processors determines a plurality of web pages that are concurrently opened in a browser. At least a first group of web pages and a second group of web pages are determined. On the browser, a mufti-panel view interface is displayed having a plurality of panels. The mufti-panel view interface concurrently provides useable content of at least some web pages of a first set of web pages in the first group in each panel. The useable content corresponds to a portion of content displayed on an individual web page. The multi-panel view interface includes a selection interface to enable a user to select to view web pages in the first group or the second group. A web page is displayed on the multi-panel view interface by expanding the useable content of that web page.

### TECHNICAL FIELD

Examples described herein pertain generally to a system and method for operating a browser on a computing device.

### BACKGROUND

A typical web browser provides a single window that displays content from a web page accessed or opened by a user. Even in situations where the user opens multiple web pages in multiple tabs of the browser, only one of the web pages can be fully displayed on the browser. The user can view a different web page that is opened on the browser by selecting an associated tab.

### BRIEF DESCRIPTION OF THE DRAWINGS

FIG. 1 illustrates an example system for operating a browser on a computing device.

FIGS. 2A and 2B illustrate example methods for operating a browser on a computing device.

FIGS. 3A and 3B illustrate an example of a mufti-panel view interface of a browser.

FIGS. 4A and 4B illustrate another example of a multi-panel view interface of a browser.

FIGS. 5A through 5E illustrate an example series of user interfaces that are displayed on a browser.

FIG. 6 is a block diagram that illustrates a computing device upon which examples described herein may be implemented.

### DETAILED DESCRIPTION

Examples described herein provide a browser for a computing device that concurrently displays content from multiple web pages in a single interface. In some examples, the single interface can be a multi-view panel interface can enable a user to view content from multiple web pages that pertain to a particular group of web pages designated by the user. The multi-view panel interface can provide features to enable the user to switch between multiple groups of web pages.

According to an example, a browser or browser application can be stored in memory and operated on a computing device. A plurality of web pages that are concurrently opened in the browser is determined. In some examples, information about each of the opened web pages can be maintained by the browser. At least a first group of web pages associated with a first set of web pages and a second group of web pages associated with a second set of web pages are determined. On the browser, a multi-panel view interface is displayed having a plurality of panels, where each panel includes useable content of some web pages of the first set of web pages. The useable content can correspond to a portion of content displayed on an individual web page. In this manner, the browser can organize web pages for a user based on groups and enable the user to visually differentiate between opened web pages.

In one example, the mufti-panel view interface can include a group selection feature that enables a user to select which group of web pages to view in the mufti-panel view interface (e.g., a first group, a second group, etc.). The user can interact with the group selection feature to switch between different sets of web pages that are opened in the browser. The group selection feature can also provide group management functionality so that the user can manage the web pages and associated groups directly from the mufti-panel view interface.

The mufti-panel view interface can also enable a user to select one of the web pages to be displayed (e.g., in majority) as compared to other web pages that are concurrently opened in the browser. For example, a user can provide an input to select one of the panels of the mufti-panel view interface. In response to the user input, the web page corresponding to the selected panel can be displayed, on the mufti-panel view interface, by expanding the useable content of that web page to an active view.

In other examples, the mufti-panel view interface can provide a plurality of panels corresponding to more than one group of web pages. Still further, depending on variations, the panels of the multi-panel view interface can be substantially similar in size or different in size.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples of the include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

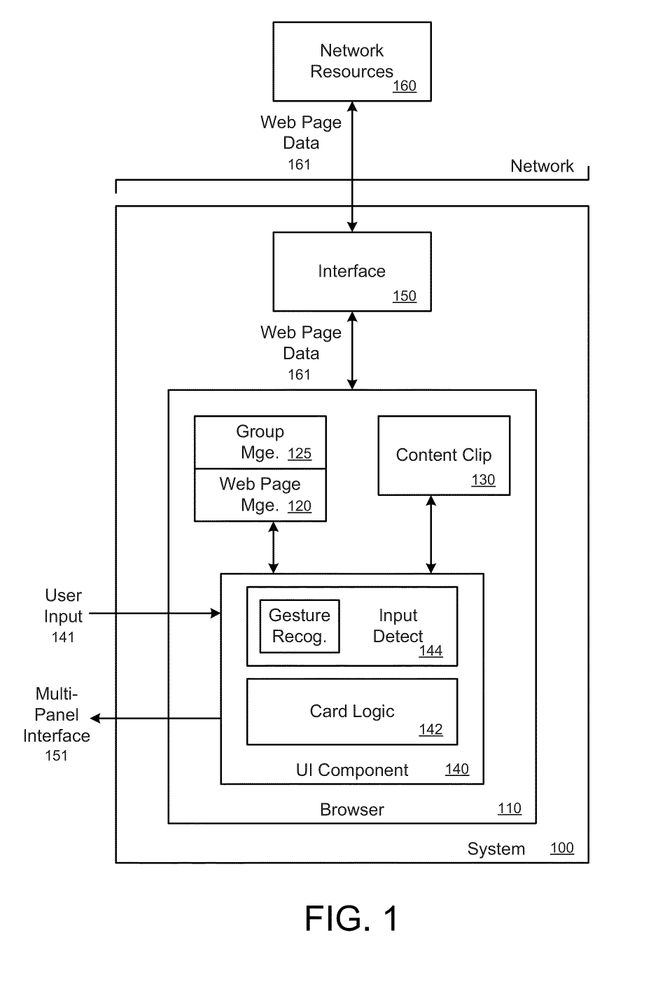

FIG. 1 illustrates an example system for operating a browser on a computing device. A system 100 such as described by an example of FIG. 1 can be implemented on a computing system, such as a desktop computer, a laptop computer, a tablet device, or a smartphone. System 100 can be configured to communicate with resources or servers over a network in order to receive and provide content on a browser.

In one example, system 100 can include a browser 110 and an interface 150 to communicate with one or more network resources 160 over a network (e.g., a local area network or the Internet). The browser 110 can include a web page manage 120, a group manage 125, a content clip 130, and a user interface (UI) component 140. The components of system 100 can combine to receive data/content from network resources and to provide a mufti-panel view interface that concurrently displays useable content corresponding to a plurality of web pages. A user of the computing device can operate one or more input mechanisms, such as a mouse, keyboard, and/or a touch-sensitive display, to control and interact with the mufti-panel view interface.

Depending on implementation, the components that are described in system 100 can be provided as individual components or modules, or as part of other components. Logic can be implemented with various applications (e.g., software) and/or with hardware of one or more computing devices that implements system 100. In some implementations, the components of system 100 can be implemented on network side resources, such as on one or more servers. System 100 can also be implemented through a combination of other computer systems in alternative architectures (e.g., peer-to-peer networks, etc.). As an addition or an alternative, one or more components of system 100 can correspond to plug-ins that can be used by a browser to provide a mufti-panel view interface.

A computer system can operate a browser 110 to retrieve and present information from network resource(s) 160 over a network, such as the Internet. For example, the information or content can be identified by a uniform resource locator (URL), and can be a web page, an image, and/or a video, etc. When a user selects a link, such as a hyperlink, or inputs a URL, the browser 110 can retrieve content (e.g., web page data 161 via the interface 150) corresponding to the link or URL from the respective network resource(s) 160, and present the content on the browser 110 (e.g., the browser 110 opens the web page in a browser window). In some cases, a user can open a plurality of different web pages concurrently.

Multi-Panel View Interface

The browser 110 can determine that there is a plurality of web pages that is opened by a user. If the browser 110 has only one web page that is opened (e.g., a first web page), the UI component 140 of the browser 110 can provide a user interface with a full screen view (or active view) of that web page. The active view enables the user to interact with the web page in a typical fashion, e.g., select links on the web page, scroll the web page, etc. The user can also operate the browser 110 to open a second web page concurrently (for example, by interacting with a tab bar or status bar interface of the browser 110 to enter another URL, or by clicking a link on the first web page to open the link as a new tab). When the browser 110 opens the second web page, the second web page can be displayed as a full screen view instead of the first web page. Each concurrently opened web page can also be associated with a tab or selectable feature so that the user can interact with the tabs or selectable features to switch between which web page to view in the full screen or active view (e.g., via user input 141).

The browser 110 can include a web page manage 120 that maintains information about each web page that is concurrently opened. The web page manage 120 can also maintain the browsing history or information about web pages that have been previously opened by a user. For each web page that is concurrently opened, the web page manage 120 can maintain information about that web page (e.g., when it was opened, the URL of the web page, etc.) and associate that web page with an identifier corresponding to a tab or selectable feature.

When more than one web page is concurrently opened, the UI component 140 can provide a multi-panel view interface 151 on the display of the computing device. A mufti-panel view interface 151 includes a plurality of panels (or cards) that each displays useable content corresponding to a concurrently opened web page and is associated with an identifier for that web page. For example, for each panel, the useable content can correspond to a portion of content that is displayed on a corresponding web page. The browser 110 can provide the mufti-panel view interface 151 in response to a user input 141 (e.g., via an input mechanism of the computing device). In one example, the browser 110 can display the multi-panel view interface 151 from a full screen view or active view of a currently displayed web page by causing the full screen or active view to be reduced in size so that (i) only a portion of the content of that web page is displayed in one of the panels (e.g., as useable content), and (ii) the other panels can be exposed.

In some examples, the UI component 140 can include card logic 142 and input detect 144. The card logic 142 can (i) determine how many web pages are concurrently opened in the browser 110 (e.g., by communicating with the web page manage 120), (ii) determine how many panels or cards are to be displayed at the same time on the mufti-panel view interface 151, (iii) determine the size of the panels, (iv) associate each panel with a particular web page that is concurrently opened in the browser 110 (e.g., using the identifier for the web page), and (v) rearrange the order or positioning of the panels in the multi-panel view interface 151 based on user input 141. For example, the card logic 142 can determine that there are three web pages concurrently opened, determine that three panels can be displayed on the multi-panel view interface 151 simultaneously, and can associate each of the three web pages with each of the panels. The card logic 142 can also determine that each of the three panels are to be substantially equal in size (e.g., each having a size that is one third of the overall browser window).

The card logic 142 can determine the size of the panels for the multi-panel view interface 151 based on (i) the number of web pages that are concurrently opened in the browser 110, (ii) the overall size of the browser window or display of the computing device, (iii) the orientation of display of the computing device (e.g., landscape or portrait orientation for a mobile or handheld device), and/or (iv) user-designated or predetermined configurations/settings. For example, the user-designated or predetermined configurations can provide that only a maximum of five panels can be displayed at once on the mufti-panel interface 151 (e.g., so that the user must scroll through the mufti-panel interface 151 to view additional panels, if there are more than five web pages that are opened). In another example, the configurations can provide that each of the plurality of panels is to be substantially equal in size. These factors that affect the size and number of panels that are displayed can be configured by a user in a menu of the browser 110. Depending on implementation, the card logic 142 can dynamically size (or re-size) the panels based on said factors so that when one or more additional web pages are opened (or one or more web pages are closed) on the browser, the sizes of the panels can be dynamically adjusted.

The UI component 140 also includes input detect 144 to detect input 141 provided by a user via one or more input mechanisms of the computing device (e.g., a touch-sensitive display, one or more buttons or switches, a keyboard, a mouse, a trackball, etc.). A user can provide user input 141 by performing gestures or by selecting displayed selectable features and panels of the multi-panel interface 151. For example, the user can perform gestures on a surface of a touch-sensitive display, or click, hold, and drag selectable features or portions of the mufti-panel view interface 151 using a mouse or trackball. The input detect 144 can use gesture recognition logic to determine what gestures are provided or inputted by the user and determine what actions correspond to those gestures. The user input 141 can be used to control what web pages are opened in the browser 110, for example, or what is to be displayed by the UI component 140 in the multi-panel interface 151 (e.g., swipe or scroll panels, expand a panel, reduce an active view of a web page to a panel, close an opened web page, etc.). Based on the user input 141, the web page manage 120 can also update or modify the information about the opened web pages and the browser's browsing history.

The UI component 140 can generate the multi-panel interface 151 using content or information about content provided by the content clip 130. For each web page opened in the browser 110, web page data 161 corresponding to that web page is received from one or more network resources 160. For each web page, the content clip 130 of the browser 110 can determine what portion of content displayed on that web page is to be presented in a corresponding panel of the mufti-panel interface 151. The content clip 130 can determine what portion of the content displayed on that web page is an important aspect of that web page (e.g., a title or heading, a main image or largest image of the web page) to be conveyed to a user.

For example, many web pages have a title or heading portion near the top of the web page or the upper-left hand corner of the web page. Similarly, many web pages can include images or large texts for a particular subject or heading near the upper region and/or center of the web page. The content clip 130 can identify such portions of the content of the web page as being an important aspect of the web page, and provide a clip of the identified portion and/or information about the identified portion (e.g., four reference points of an x-y coordinate system of that web page) to the UI component 140.

The content clip 130 can also determine what portion of the content to identify based on the size of the panels of the multi-panel interface 151. For example, the content clip 130 can work in conjunction with the card logic 142 of the UI component 140 to determine the panel sizes for the mufti-panel interface 151. The size of an identified portion of a web page can vary based on the size of its corresponding panel. The UI component 140 can display, for each panel, useable content that corresponds to a portion of the content identified by the content clip 130 for that web page.

Grouping Web Pages

The browser 110 also includes group manage 125 to maintain information about the grouping of web pages. Depending on implementation, the group manage 125 can communicate with or be a part of the web page manage 120 of the browser 110. When there are multiple web pages that are opened in the browser 110, a user can select one or more web pages as being associated with a particular group. The user can also create multiple groups in the browser. Information about the groups that are designated by the user can be maintained by the group manage 125. For example, the group manage 125 can associate individual identifiers corresponding to web pages with one or more group identifiers.

Depending on implementation, the mufti-panel view interface 151 can display panels of web pages corresponding to only a particular group of web pages. In such examples, the mufti-panel view interface 151 can include a group selection feature to enable the user to switch between viewing different groups of web pages (e.g., select a feature to view a different group than the group of web pages currently displayed on the multi-panel view interface 151). In another example, the multi-panel view interface 151 can display panels of web pages corresponding to multiple groups simultaneously. When panels corresponding to multiple groups (or one group and other web pages that are not in a group) are presented in the multi-panel view interface 151, one or more graphic features can be provided to indicate which panels belong to which group. In either example, the user can update and manage the group(s) of web pages by interacting with and providing user input 141 on the multi-panel view interface 151.

In this manner, the multi-panel view interface 151 can provide information about which web pages (or groups of web pages) are opened in the browser 110 as visual and useable content for the user. In addition, the grouping of web pages provides additional organization of opened web pages for the user. The user can browse through the panels and select a panel to view the corresponding website as an active view. When the user makes a selection of a panel using the user input 141, the UI component 140 can cause the selected web page to be viewed as an active view on the multi-panel view interface 151 by expanding the useable content within that panel to the active view.

Methodology

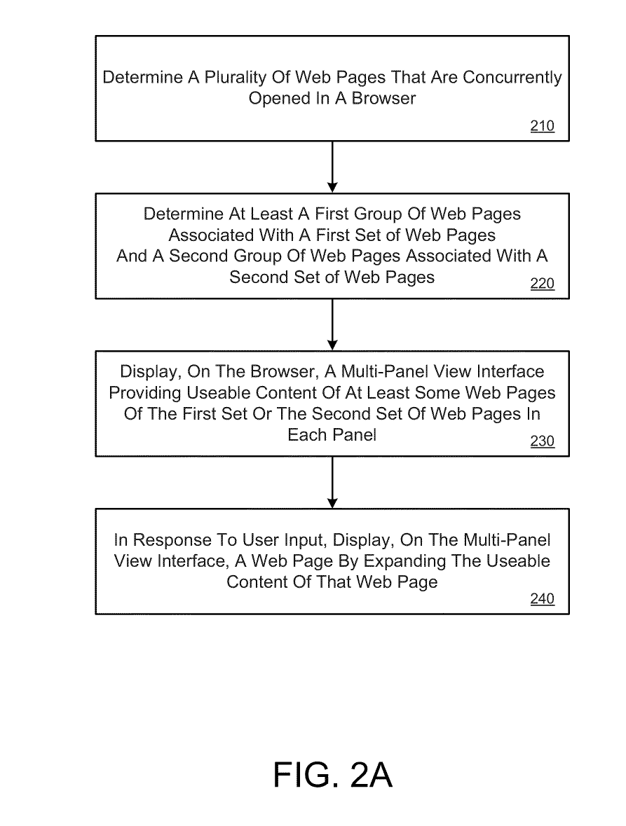

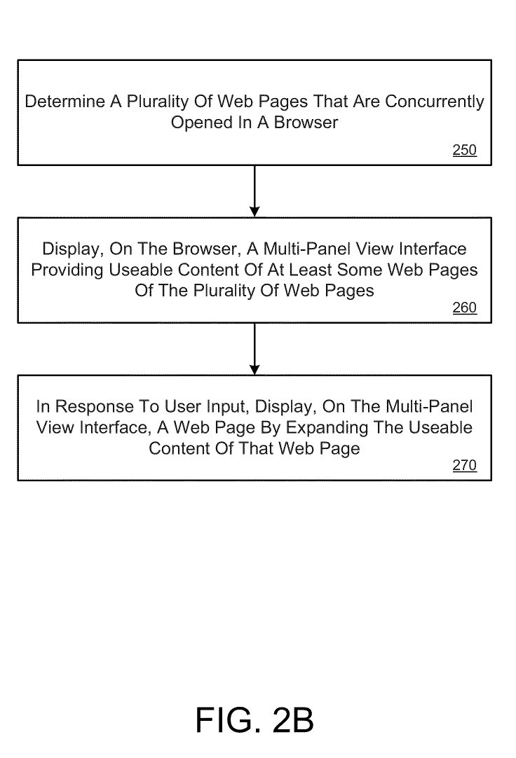

FIGS. 2A and 2B illustrate example methods for operating a browser on a computing device. Method such as described by FIGS. 2A and 2B can be implemented using, for example, components described with an example of FIG. 1. Accordingly, references made to elements of FIG. 1 are for purposes of illustrating a suitable element or component for performing a step or sub-step being described.

Referring to FIG. 2A, a plurality of web pages can be opened concurrently in a browser 110. The browser 110 can include a web page manage 120 that maintains information about web pages that are concurrently opened. The browser 110 can determine when there are more than one web page concurrently opened (210). When a plurality of web pages is concurrently opened, the browser 110 can determine a first group of web pages associated with a first set of web pages and/or a second group of web pages associated with a second set of web pages (and/or additional groups) (220). In one example, the groups can be designated by a user and information about the groups can be maintained by the group manage 125.

A multi-panel view interface 151 can be displayed, on the browser, having a plurality of panels that each displays useable content of at least some web pages of the first set of web pages or the second set of web pages (230). The useable content of a web page can correspond to a portion of content displayed on that web page and be displayed in a corresponding panel with an associated identifier or tab. In this manner, for example, portions of web pages that have been designated or selected by the user as belonging to a first group (as opposed to a second group) can be displayed concurrently displayed on the mufti-panel view interface 151. In such cases, the mufti-panel view interface 151 can also include a group selection feature to enable the user to view different groups of web pages in the multi-panel view interface 151.

When the user selects one of the panels displayed in the multi-panel view interface 151, the corresponding web page can be displayed on the mufti-panel user interface by expanding the useable content in that panel to an active view (240). Similarly, the user can reduce in size the web page from the active view back to the useable content within a panel by interacting with the multi-panel view interface 151 so that only a portion of the content of that web page is displayed in one of the panels, and the other panels can be exposed.

FIG. 2B illustrates another example for operating a browser on a computing device. FIG. 2B is similar to that of FIG. 2A, but the browser 110 does not determine a group of web pages in which to display content in the multi-panel view interface 151. The browser 110 can determine when there a plurality of web pages concurrently opened (250). When a plurality of web pages is concurrently opened, the browser 110 can display a mufti-panel view interface 151 having a plurality of panels (260). Each panel can include useable content of some web pages of the plurality of web pages that are opened. For example, ten web pages can be opened in the browser 110, without any web pages being designated as being part of a group. The multi-panel view interface 151 can concurrently display five panels corresponding to five of the ten web pages. The user can provide input to view other panels by swiping or scrolling through to view other panels not currently shown on the mufti-panel view interface 151.

In one variation, a group can be associated with a set of web pages. In FIG. 2B, panels corresponding to web pages in that group can be displayed with panels corresponding to web pages that are not in that group or in another group. In this manner, multiple web pages of multiple groups can be displayed as panels in the same mufti-panel view interface 151. For example, two web pages can be in one group and useable content for the two web pages can be individually displayed in two panels. Two additional panels corresponding to web pages that are not designated in any group or are designated in different groups can also be displayed in the mufti-panel view interface 151.

The user can select one of the panels displayed in the mufti-panel view interface 151. In response to the user input, a corresponding web page can be displayed on the multi-panel user interface by expanding the useable content in the selected panel to an active view (270).

### EXAMPLES

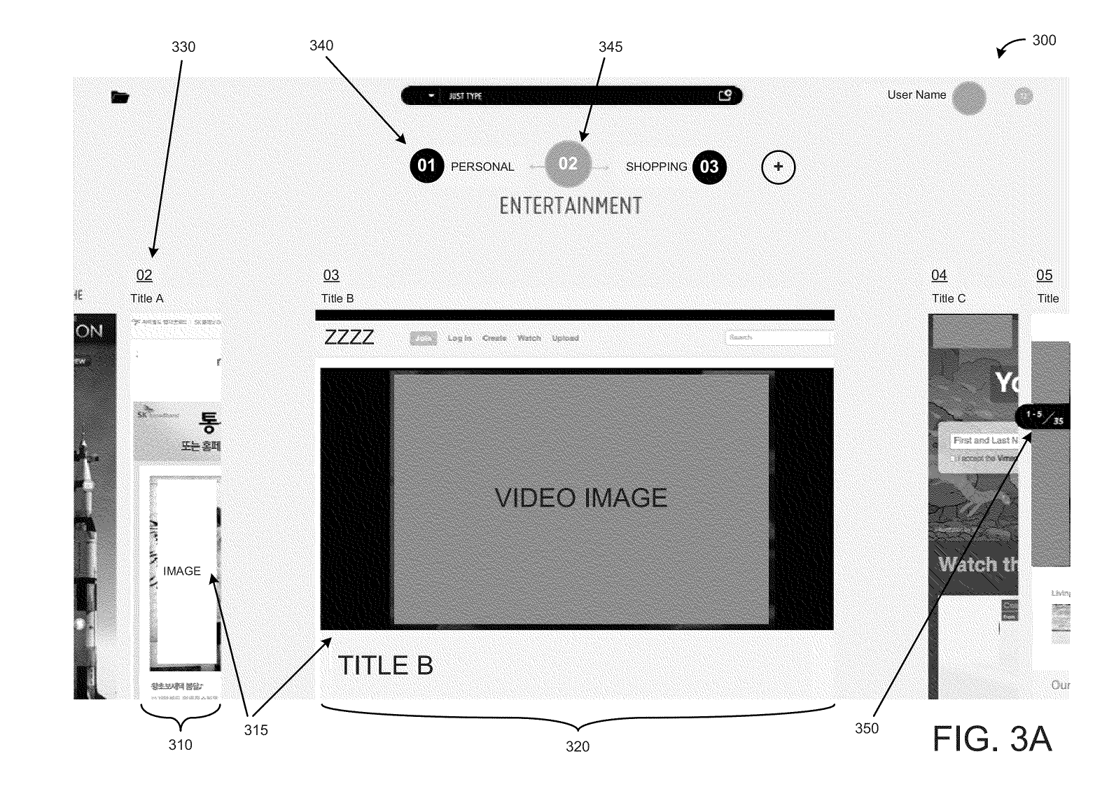

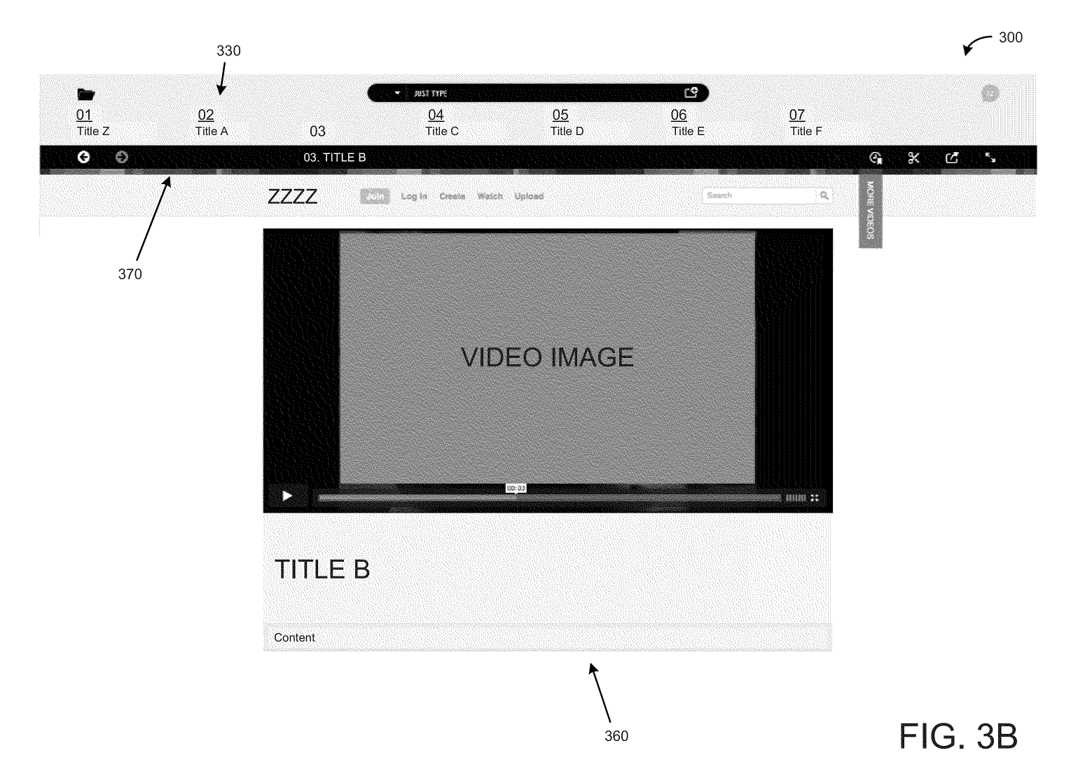

FIGS. 3A and 3B illustrate an example of a multi-panel view interface of a browser. A mufti-panel view interface 300 as described in FIGS. 3A and 3B can be an example of a mufti-panel view interface as discussed with respect to FIGS. 1 through 2B.

The mufti-panel view interface 300 can include a plurality of panels 310, 320. In the example of FIG. 3A, the mufti-panel view interface 300 provides three panels and portions of two panels (so that portions of the panels are hidden or off the display). The panels can have different sizes and have different size spacing between the panels. For example, one of the panels 320 is significantly larger in size compared to the other panels 310 and is positioned in a center region of the multi-panel view interface 300. Each panel corresponds to a web page that is opened in the browser and includes useable content 315 that corresponds to a portion of the content displayed on that web page. Because the useable content corresponds to a portion of content that is displayed on a web page, in some examples, the useable content can be of a portion of a video that is being played in the browser. In the mufti-panel view interface 300, the useable content of a panel can display an image corresponding to the video or continue to play the video.

Each panel can also include an identifier 330 and a title or portion of the title. Depending on implementation, each identifier 330 can be selectable to enable the user to (i) rearrange the order of the panels (e.g., by selecting an identifier 330 and dragging from one location to another location between two panels), (ii) close the corresponding web page and panel (e.g., by selecting the identifier 330 and swiping it up or down), or (iii) scroll through the panels to cause the panel with the selected identifier 330 to be positioned in the center region.

The mufti-panel view interface 300 can also include a group selection feature 340 that includes one or more selectable group identifiers 345. In one example, the mufti-panel view interface 300 can provide panels 310, 320 of web pages that have been designated (e.g., by the user) to be in a particular group. In the example of FIG. 3A, the group of web pages that are displayed in the panels 310, 320 correspond to a group with an identifier “02” and labeled as “entertainment.” The user can select another identifier of a different group (e.g., “personal” or “shopping”) to view panels of web pages corresponding to the different groups, and can edit the labels of the groups. The selectable feature “02” is provided with a different visual distinction that the other selectable features to identify to the user which group of web pages the user is currently viewing in the mufti-panel view interface 300.

The mufti-panel view interface 300 can also include a web page indicator 350 that displays, when necessary, for example, a first set of numbers (e.g., “1-5”) depicting which set of panels are currently provided in the mufti-panel view interface 300, and a second number (e.g., “35”) depicting the total number of panels that are opened. Depending on variations, this second number can correspond to a number of web pages that are in a particular group of web pages that are currently displayed as panels, or can correspond to a total number of web pages that are opened in the browser. A user can view the web page indicator 350 to determine that he or she is currently viewing panels 1 through 5, and that additional panels can be seen on the mufti-panel view interface 300 by scrolling through to view other panels via user input.

For example, the user can interact with the mufti-panel view interface 300 using one or more gestures on a touch-sensitive display (e.g., on a tablet device) or by clicking and dragging displayed features using a cursor controlled by a mouse (e.g., when operating a browser on a laptop computer or desktop computer). The user can scroll (e.g., left to right or vice versa, or top to bottom or vice versa) to view additional panels (such as panels that are not shown or panels that are only shown in portion) on the multi-panel view interface 300. In the example of FIG. 3A, as the user scrolls the panels so that a different panel than panel “03,” such as panel “04,” is positioned in the center region, the size of panel “03” reduces in size as it moves left and the size of panel “04” increases size as it moves towards the center region. In this manner, the mufti-panel view interface 300 can enable a larger portion of useable content to be viewable by the user when the corresponding panel is moved towards the center region.

The user can also interact with the mufti-panel view interface 300 to display a majority of only one web page on the multi-panel view interface 300. For example, the user can select panel 320 to cause the panel 320 to expand the useable content 315 of that panel to an active view of the web page. FIG. 3B illustrates the mufti-panel view interface 300 when the panel 320 has been selected by the user. The useable content 315 has expanded in size to display the web page corresponding to the panel 320 in a full view or active view 360. Once the mufti-panel view interface 300 displays an active view 360 of the web page, the user is enabled to interact with the web page in a typical fashion, e.g., select links, scroll the page, pause a video, play a video, etc.

In addition, when the mufti-panel view interface 300 displays the active view 360, a browser command bar or menu bar 370 can also be provided. The browser command or menu bar 370 can include a “back” feature and a “forward” feature, as well as other menu functionalities. In one example, the title of the web page can be displayed in a region of the browser command or menu bar 370. When the user selects the title in the region of the browser command or menu bar 370, the URL of that web page can be displayed in place of or in addition to the title.

In FIG. 3B, the user can interact with the active view 360 of the multi-panel view interface 300 to select other identifiers or selectable features 330. Selecting another identifier 330 can cause the associated web page to be displayed in the active view 360 without first displaying a plurality of panels, as illustrated in FIG. 3A. The user can reduce the active view 360 of the web page in order to view the plurality of panels in the multi-panel view interface 300 by performing a gesture or by clicking and dragging on the browser command or menu bar 370 (e.g., swipe up or swipe down). In response to the user input, the active view 360 can be reduced in size so that the plurality of panels can be shown in the mufti-panel view interface 300 of FIG. 3A.

As an addition or an alternative, when the mufti-panel view interface 300 displays the active view 360, the row of tabs or selectable features 330 can be hidden from view. In such an example, the active view 360 can be larger in size with the browser command or menu bar 370 being closer to the top of the mufti-panel view interface 300 (as compared to what is illustrated in FIG. 3B). In order for a user to view the selectable features 330 of other web pages that are concurrently opened, the user can interact with the browser command or menu bar 370. For example, the user can make a swiping motion on (e.g., upward or downward gesture) or tap on the browser command or menu bar 370, to reveal the row of selectable features 330, such as illustrated in FIG. 3B.

Referring back to FIG. 3A, the user can manage or update groups of web pages by interacting with the multi-panel view interface 300. For example, the user has created three groups, labeled “personal,” “entertainment,” and “shopping.” In FIG. 3A, panels corresponding to a set of web pages that have been grouped in the “entertainment” group are displayed in the mufti-panel view interface 300. The user can select, and drag and drop a panel 310 and/or a corresponding selectable feature 330 (e.g., such as a panel identified by “04” or “05”) to one of the group identifiers “01” or “03,” for example, to move the associated web page of that panel to the “personal” group or the “shopping” group. Similarly, the user can select, and drag and drop a panel 310 and/or a corresponding selectable feature 330 to the “+” feature to create a new group with the selected web page. In another example, the user can select and swipe a panel (e.g., up or down) to remove the web page from the existing group or close the web site entirely. In this manner, the user can manage and edit groups of web pages directly from the mufti-panel view interface 300 without having to open a separate interface or menu.

Although five panels are illustrated in the example described in FIG. 3A, other variations can include a different number of panels that are concurrently displayed on a mufti-panel view interface 300, such as three or seven. Other examples can include four panels or six panels, etc., with two large panels being positioned in a center region (e.g., side by side) as opposed to a single large panel in the center region.

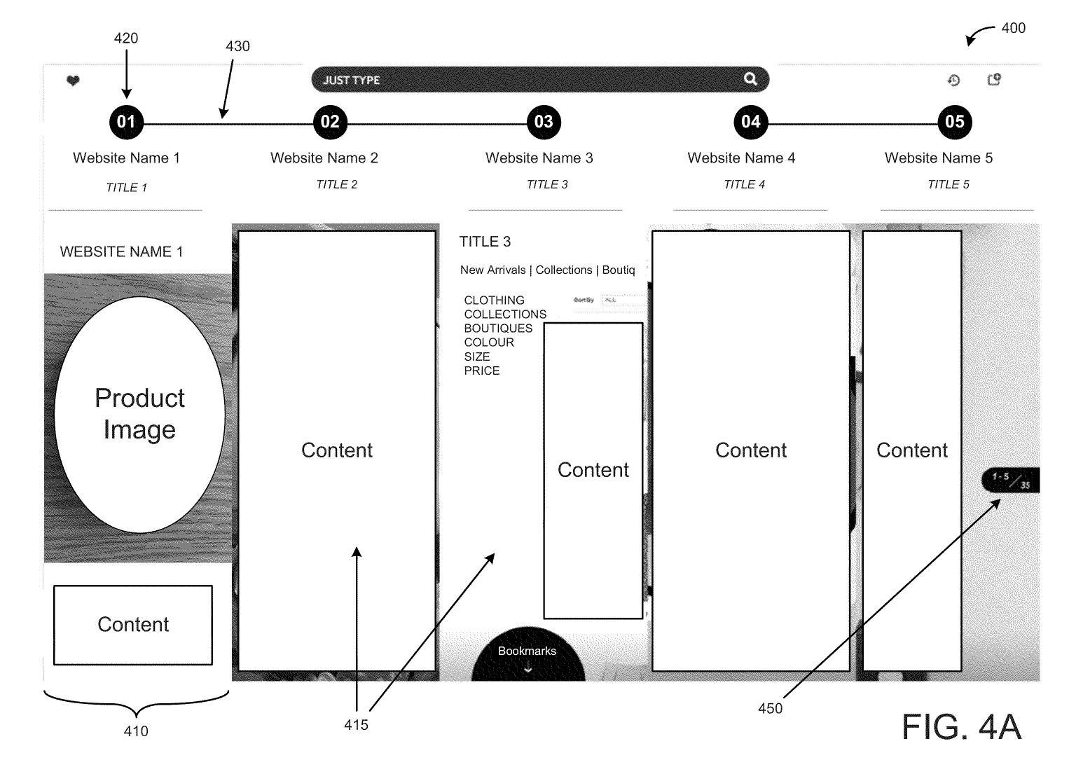

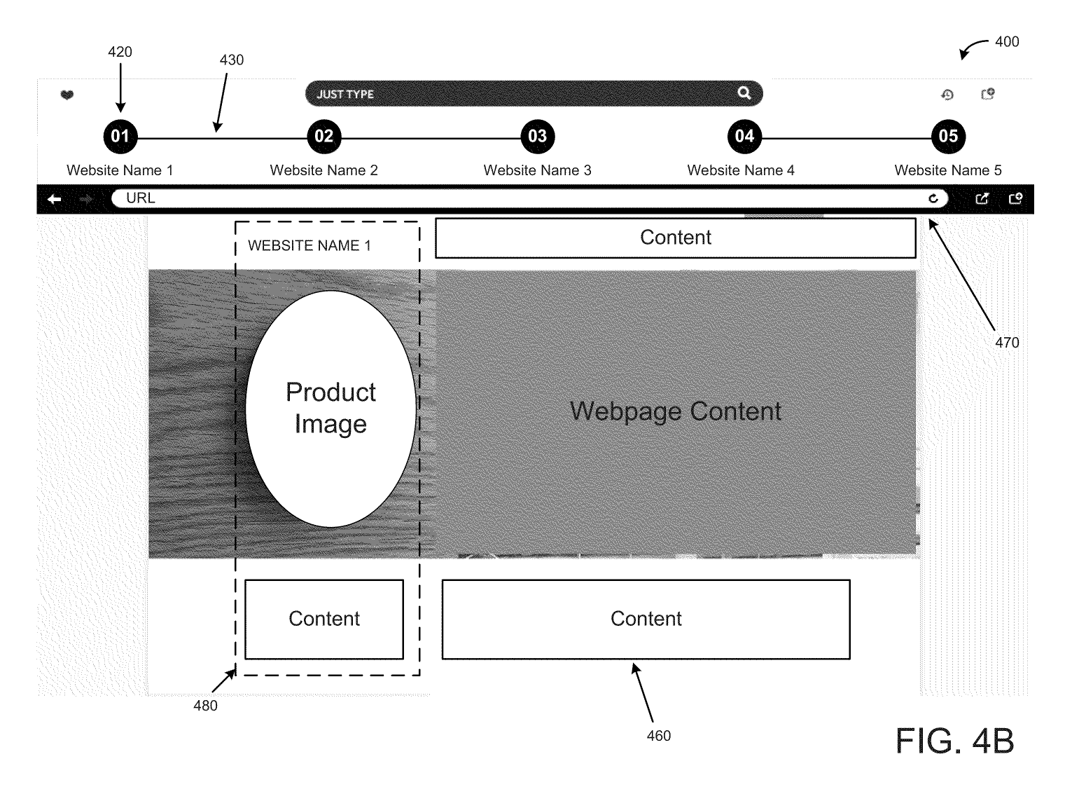

FIGS. 4A and 4B illustrate another example of a multi-panel view interface of a browser. In one example, FIGS. 4A and 4B can be a modification of FIGS. 3A and 3B, and have similar features and characteristics of FIGS. 3A and 3B. A multi-panel view interface 400 as described in FIGS. 4A and 4B can be an example of a mufti-panel view interface as discussed with respect to FIGS. 1 through 2B.

The mufti-panel view interface 400 of FIG. 4A can include a plurality of panels 410. In the example of FIG. 4A, five panels 410 are displayed in the mufti-panel view interface 400, with each panel 410 having substantially the same size and including useable content corresponding to a particular web page that is opened in the browser. Each panel 410 can have an associated identifier or selectable feature 420, a web page domain, and a title of the web page. The multi-panel view interface 400 can also include a web page indicator 450 that displays, when necessary, for example, a first set of numbers (e.g., “1-5”) depicting which set of panels are currently provided in the multi-panel view interface 400, and a second number (e.g., “35”) depicting the total number of panels that are opened in the browser. The user can view additional panels 410 and corresponding features by scrolling the panels (e.g., left to right or right to left).

In one example, the panels 410 that are concurrently provided in a mufti-panel view interface 400 can correspond to (i) no groups (e.g., the user has not designated or created any groups), (ii) one group, or (iii) more than one group. In the example of FIG. 4A, the user has designated two groups of web pages. A first group includes the web pages identified by “01,” “02,” and “03,” while a second group includes the web pages identified by “04,” and “05.” One or more graphic features 430 can be provided with the groups to indicate which sets of web pages are grouped together as compared to other groups. A graphic feature 430 can include (i) a line that connect the identifiers or selectable features 420 of a group, (ii) a lines with different shading, color, and/or thickness, (iii) a shape encircling the identifiers or selectable features 420 of a group, and/or (iv) different colors, shadings, fillers for the identifiers or selectable features 420 of a group.

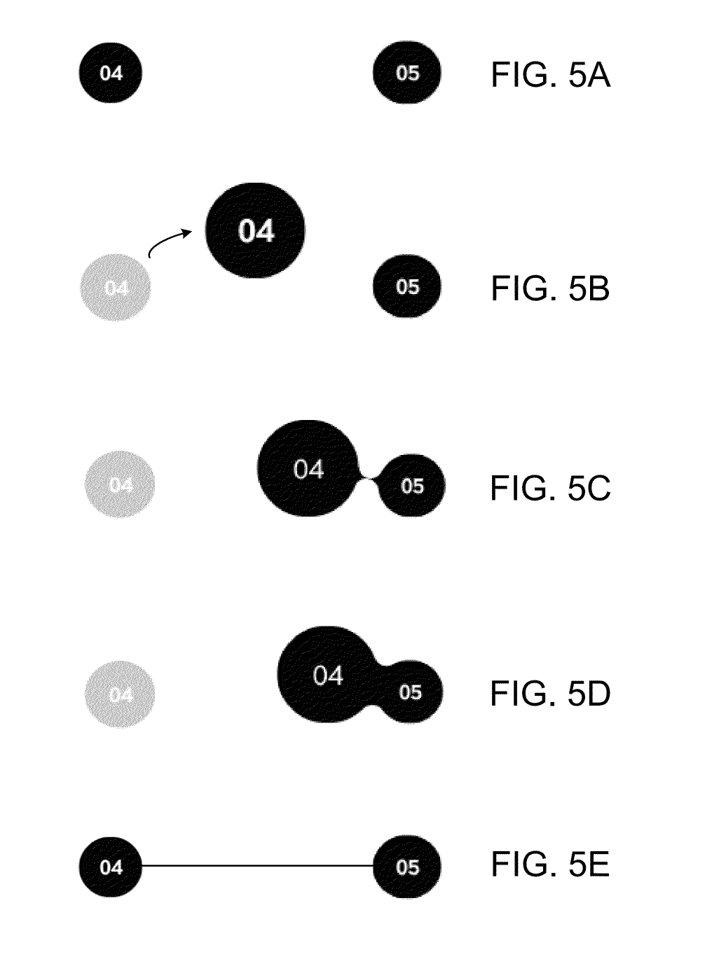

The mufti-panel view interface 400 can enable the user to manage and edit groups of web pages directly from the mufti-panel view interface 400. For example, the user can remove the web page corresponding to the identifier “03” from the group by making a swiping gesture (which can represent a “cut” action) through the graphic feature 430 between “02” and “03.” The gesture recognition logic of the input detect 142, for example, can detect the swiping gesture through the line at that location as being an action to sever the line and remove “03” from the group. In another variation, the user remove “03” from the group by selecting and dragging the identifier “03” away from its default position at least a predetermined amount to cause the line 430 to break. In another example, the user can create a group with two or more web pages by selecting and dragging an identifier and dropping the identifier to another identifier (e.g., discussed in FIGS. 5A-5E).

The user can select panel 410 to cause the panel 410 to expand the useable content 415 of that panel to an active view of the web page. FIG. 4B illustrates the multi-panel view interface 400 when the panel 410 has been selected by the user. The useable content 415 has expanded in size to display the web page corresponding to the panel 410 in a full view or active view 460. Once the mufti-panel view interface 400 displays an active view 460 of the web page, the user is enabled to interact with the web page in a typical fashion, e.g., select links, scroll the page, pause a video, play a video, etc. The multi-panel view interface 400 can also provide a browser command bar or menu bar 470.

Referring back to FIG. 1, the content clip 130 of the browser 110 can determine what portion of content displayed on a web page is to be selected as useable content for a panel. FIG. 4B illustrates a portion 480 that has been identified by the content clip 130 as being an important aspect of the web page to display as useable content in the panel 410 of FIG. 4A. The portion 480 includes a heading or name, “nest,” and can be cropped from the active view 460 or identified using four reference points of an x-y coordinate system. The portion 480 can vary in size based on the size of the panels of the mufti-panel view interface 400. While five panels 410 are illustrated in FIG. 4A, in other variations, only three panels can be provided in the mufti-panel view interface 400, so that each panel can be larger in size than the panels 410 of FIG. 4A.

As discussed, the useable content of a panel 410 can correspond to a cropped or identified portion of the displayed content of an individual web page. In such cases, the useable content has a substantially similar proportion to that of the displayed content of the web page (e.g., the useable content itself is not shrunk or expanded as compared to the displayed content). For example, the useable content 415 of the panel 410 of FIG. 4A displays the image and the heading “nest” in substantially the same form and size as the portion 480 in the active view 460 of FIG. 4B. In other variations, the useable content of a panel can be shrunk or enlarged as compared to the displayed content of the corresponding web page.

FIGS. 5A through 5E illustrate an example series of user interfaces that are displayed on a browser. In FIG. 5A, two identifiers or selectable features (such as illustrated in FIGS. 4A and 4B) corresponding to two web pages are provided. The two selectable features, “04” and “05,” are not yet associated with a group as no graphic feature or distinction is provided between the two selectable features.

In FIG. 5B, the user has selected (via an input mechanism) the selectable feature “04” and has started to drag it over to the selectable feature “05.” As the user makes this motion, the selectable feature “04” expands in size to make obvious to the user which feature the user has selected. In FIG. 5C, as the user moves the selectable feature “04” within a vicinity or predetermined area around the selectable feature “05,” portions of the selectable features begin to morph and touch each other. As the selectable feature “04” is brought even closer to (or overlaps) the selectable feature “05,” the two selectable features begin to combine. At this point, for example, when the user releases the selectable feature “04,” the browser determines that the web pages for the selectable features are to be grouped together and a graphic feature is provided to indicate the grouping, as illustrated in FIG. 5E.

Hardware Diagram

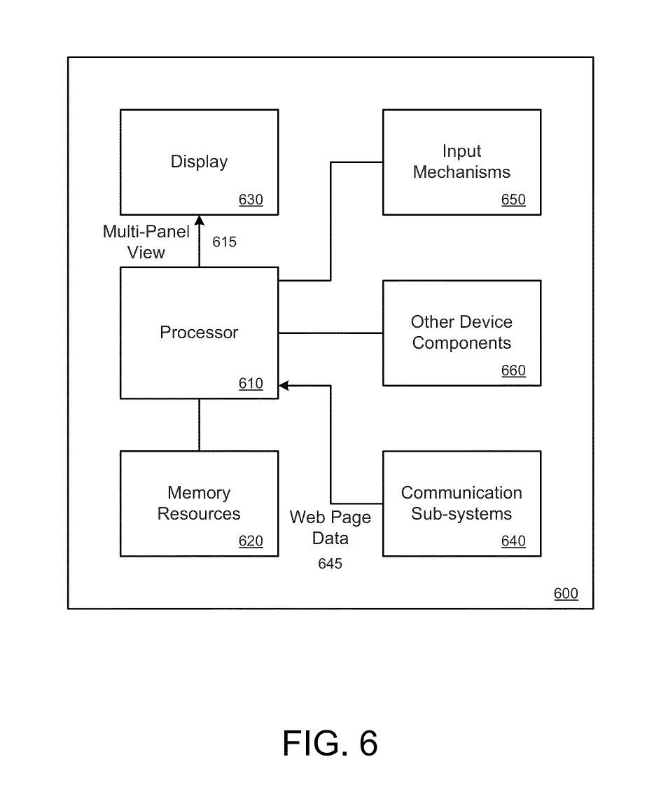

FIG. 6 is a block diagram that illustrates a computing device upon which examples described herein may be implemented. In one example, a computing device 600 may correspond to a desktop computer, a laptop computer, or a mobile computing device, such as a cellular device that is capable of telephony, messaging, and data services. Examples of such devices include smartphones, handsets, or tablet devices. Computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more other device components (e.g., a GPS component, output devices, camera component, etc.) 660.

The processor 610 is configured with software and/or other logic to perform one or more processes, steps and other functions described with implementations, such as described by FIGS. 1 through 5, and elsewhere in the application. Processor 610 is configured, with instructions and data stored in the memory resources 620, to operate a browser as described in FIGS. 1 through 5. For example, instructions for operating the browser to display a mufti-panel view interface 615, such as described in FIGS. 1 through 5, can be stored in the memory resources 620 of the computing device 600. In one implementation, a user can operate the browser to open and view a plurality of web pages retrieved from over a network. When the user operates the browser, web page data 645 can be retrieved (e.g., by the browser) from the network using communication sub-systems 640.

The communication sub-systems 640 can enable the computing device 600 to communicate with one or more networks (e.g., the Internet) through use of a network link (wireless or wireline). Using the network link, computing device 600 can communicate with other computer systems, such as network resources and servers, to receive or retrieve web page data 645. The browser can use the web page data 645 to provide a mufti-view panel interface 615, as described with FIGS. 1 through 5. In one example, at least one of the communication sub-systems 640 sends and receives cellular data over data channels and voice channels.

The processor 610 can cause user interface features of the browser to be presented on the display 630 by executing instructions and/or applications that are stored in the memory resources 630. In some implementations, the user can interact with a touch-sensitive display 630 to provide inputs on the multi-panel view interface 615 to manage groups of web pages and to control which web pages to view and/or which panels to view, etc.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A method for operating a computing device, the method being performed by one or more processors and comprising:
determining a plurality of web pages that are concurrently opened in a browser;
determining at least a first group of web pages associated with a first set of web pages and a second group of web pages associated with a second set of web pages;
displaying, on the browser, a multi-panel view interface having a plurality of panels, the multi-panel view interface concurrently providing useable content of at least some web pages of the first set of web pages in each panel, the useable content corresponding to a portion of content displayed on an individual web page, wherein the multi-panel view interface includes a selection feature to enable a user to select to view web pages in the first group or the second group; and
in response to a user input, displaying, on the multi-panel view interface, one of the web pages of the first set of web pages by expanding the useable content of that web page.

2. The method of claim 1, wherein displaying the multi-panel view interface includes determining a number of web pages in the first set of web pages, and wherein a size of each panel of the mufti-panel view interface is based on the number of web pages in the first set of web pages.

3. The method of claim 2, wherein displaying the multi-panel view interface includes determining which portion of displayed content of each of the at least some web pages is to be cropped and provided as useable content in each panel.

4. The method of claim 1, wherein displaying the multi-panel view interface includes providing a first panel in a center region of the mufti-panel view interface, wherein when the first panel is in a center region, the first panel has a size that is greater than other panels of the plurality of panels.

5. The method of claim 4, wherein displaying the multi-panel view interface includes enabling the user to reposition the plurality of panels in order to cause a second panel different from the first panel to be positioned in the center region, wherein when the second panel is positioned in the center region, the first panel reduces in size and the second panel has a size that is greater than other panels of the plurality of panels.

6. The method of claim 1, wherein displaying, on the mufti-panel view interface, one of the web pages includes concurrently displaying a plurality of selectable features corresponding to the at least some web pages of the first set of web pages in the first group.

7. A non-transitory computer-readable medium storing instructions that, when executed by one or more processors, causes the one or more processors to:
determine a plurality of web pages that are concurrently opened in a browser;
determine at least a first group of web pages associated with a first set of web pages and a second group of web pages associated with a second set of web pages;
display, on the browser, a mufti-panel view interface having a plurality of panels, the multi-panel view interface concurrently providing useable content of at least some web pages of the first set of web pages in each panel, the useable content corresponding to a portion of content displayed on an individual web page, wherein the mufti-panel view interface includes a selection feature to enable a user to select to view web pages in the first group or the second group; and
in response to a user input, display, on the mufti-panel view interface, one of the web pages of the first set of web pages by expanding the useable content of that web page.

8. The non-transitory computer-readable medium of claim 7, wherein the instructions cause the one or more processors to display the multi-panel view interface by determining a number of web pages in the first set of web pages, and wherein a size of each panel of the mufti-panel view interface is based on the number of web pages in the first set of web pages.

9. The non-transitory computer-readable medium of claim 8, wherein the instructions cause the one or more processors to display the multi-panel view interface by determining which portion of displayed content of each of the at least some web pages is to be cropped and provided as useable content in each panel.

10. The non-transitory computer-readable medium of claim 7, wherein the instructions cause the one or more processors to display the multi-panel view interface by providing a first panel in a center region of the multi-panel view interface, wherein when the first panel is in a center region, the first panel has a size that is greater than other panels of the plurality of panels.

11. The non-transitory computer-readable medium of claim 10, wherein the instructions cause the one or more processors to display the multi-panel view interface by enabling the user to reposition the plurality of panels in order to cause a second panel different from the first panel to be positioned in the center region, wherein when the second panel is positioned in the center region, the first panel reduces in size and the second panel has a size that is greater than other panels of the plurality of panels.

12. The non-transitory computer-readable medium of claim 10, wherein the instructions cause the one or more processors to display, on the multi-panel view interface, one of the web pages by concurrently displaying a plurality of selectable features corresponding to the at least some web pages of the first set of web pages in the first group.

13. A method for operating a computing device, the method being performed by one or more processors and comprising:
determining a plurality of web pages that are concurrently opened in a browser;
displaying, on the browser, a multi-panel view interface having a plurality of panels, the multi-panel view interface concurrently providing useable content of at least some web pages of the plurality of web pages in each panel, the useable content corresponding to a portion of content displayed on an individual web page, wherein the multi-panel view interface includes one or more graphic features that indicates that a first set of the at least some web pages is associated with a first group; and
in response to a user input, displaying, on the multi-panel view interface, one of the web pages of the at least some web pages by expanding the useable content of that web page.

14. The method of claim 13, wherein displaying the multi-panel view interface includes (i) determining a number of web pages in the first set of web pages, wherein a size of each panel of the multi-panel view interface is based on the number of web pages in the first set of web pages, and (ii) determining which portion of displayed content of each of the at least some web pages is to be cropped and provided as useable content in each panel.

15. The method of claim 13, wherein the one or more graphic features includes a line that connects two or more selectable features each corresponding to a web page in the first set.
